(19) United States
(12) Patent Application Publication
(10) Pub. No.: US 2010/0304327 A1
(43) Pub. Date: Dec. 2, 2010

(54) INTERPROXIMAL TEETH CLEANING APPARATUS WITH AN AIR-DRIVEN SPRAY

(75) Inventors: Joseph W. Grez, North Bend, WA (US); Paulus Cornelis Duineveld, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/680,209

(22) PCT Filed: Oct. 20, 2008
(86) PCT No.: PCT/IB2008/054308

§ 371 Date: Mar. 26, 2010

Related U.S. Application Data
(60) Provisional application No. 60/981,714, filed on Oct. 22, 2007.

(51) Int. Cl. A61C 17/022

(52) U.S. Cl. 433/88

(57) ABSTRACT

Interproximal cleaning is produced by a combination of fluid droplets producing a certain impact shear stress on the interproximal biofilm combined with shear stress created by the effect of air driving a liquid film (18, 20) in the interproximal surfaces. The shear stress created by the droplets decreases with the depth of the interproximal space, while the shear stress produced by the air-driven liquid film increases with interproximal depth. The combined shear is at least as great as the shear stress necessary to remove biofilm from the interproximal surfaces.

This invention relates generally to teeth cleaning devices using a fluid droplet spray, and more particularly concerns cleaning of the interproximal areas of the teeth with such a spray.

It is well known that effective interproximal cleaning of teeth, i.e. cleaning the space between adjacent teeth, is difficult to achieve. Typically, regular flossing produces the best interproximal cleaning results. However, flossing is time consuming, is often difficult to manage effectively and sometimes can be painful, resulting in bleeding of the gums.

Accordingly, it would be desirable to have an effective interproximal cleaning device which efficiently produces interproximal cleaning, at least as good as flossing.

Accordingly, there is disclosed herein an apparatus for cleaning the interproximal areas of teeth, comprising: a source of liquid droplets; a source of gas for driving the liquid droplets toward the teeth; and a nozzle and guidance tip for directing the liquid droplets into an interproximal area of the teeth, wherein the guidance tip is formed so that droplets are directed at a sufficient angle to impact interproximal surfaces and create a droplet impact shear stress on interproximal biofilm, and further so that a liquid film is produced on the interproximal surfaces, wherein gas from the source thereof drives said fluid film to create a fluid film shear stress on the interproximal biofilm, wherein the combination of the droplet impact shear stress and the fluid film shear stress is at least as great as the shear stress required to remove the biofilm on substantially the entire interproximal surfaces, producing a cleansing effect on the interproximal surfaces.

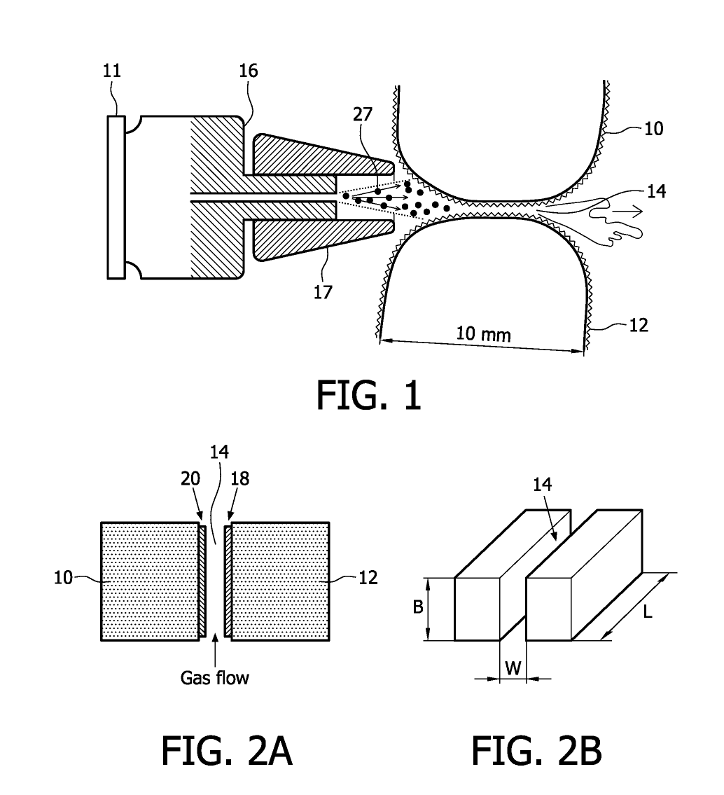

FIG. 1 is an isometric view showing a portion of a cleaning device relative to an interproximal area of the teeth.

FIGS. 2A and 2B are simplified diagrams of an interproximal area.

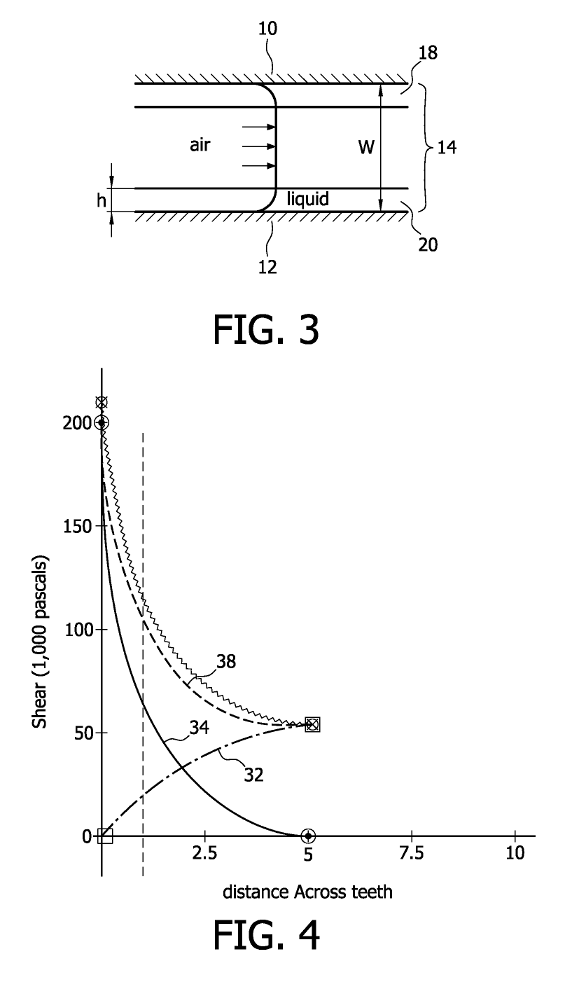

FIG. 3 is a diagram showing the velocity profile of airflow in the interproximal area when the air has a uniform velocity and liquid flow is fully developed.

FIG. 4 is a diagram showing the shear stress created by fluid droplets and gas-driven fluid on plaque biofilm relative to the interproximal distance.

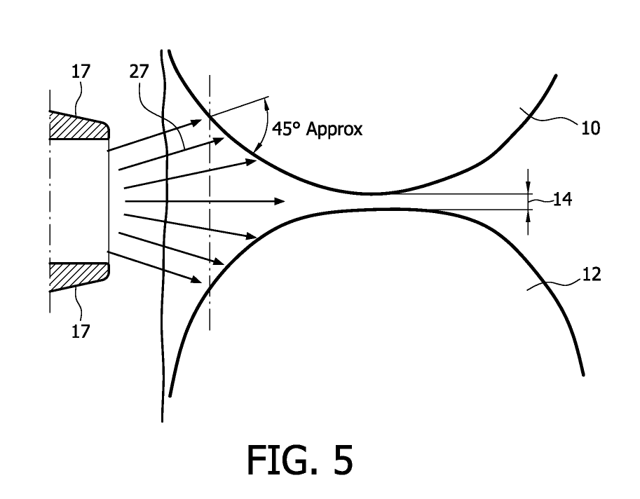

FIG. 5 is a diagram showing the impact of fluid droplets in the interproximal area.

The apparatus described and shown herein produces a spray of liquid droplets which impact directly the interproximal surfaces of adjacent teeth and which also produces a thin film of liquid on the interproximal surfaces of adjacent teeth. The liquid can be water, or various other liquids with different viscosities. Devices for developing a liquid droplet spray are well known. One example is shown and described in published patent application WO 2005070324, which is owned by the assignee of the present invention. The contents of that application are hereby incorporated by reference. Typically, such devices produce useful cleaning results when the fluid droplets impact the teeth surfaces within a relatively narrow range relative to 90° to the surface of the teeth. These devices include gas-assisted embodiments to accelerate the fluid droplets by the use of a high-speed gas.

The droplets impact the teeth surfaces and clean away biofilm plaque present on the teeth. It has been estimated that the shear stress necessary to remove plaque biofilm from the front of teeth surfaces is approximately 2×10⁵ Pa (Pascals). In some arrangements, liquid present on the teeth surfaces due to accumulation from the operation of the droplet system interferes with effective biofilm removal. In such a case, a gas such as air is used to clear a portion or all of the fluid from a particular area, allowing the normal cleaning effect of the fluid droplets on the biofilm to occur in that area. This is shown and described in published patent application No. WO 2007/072429, also owned by the assignee of the present invention. The contents of that application are also incorporated by reference.

The present apparatus accomplishes interproximal cleaning through a combination of shear stress created by air-driving a fluid film present on the interproximal surfaces of the teeth, and shear stress produced by fluid droplets impacting directly the plaque biofilm on the interproximal surfaces of the teeth. FIG. 1 shows a diagram of two adjacent teeth 10 and 12, defining an interproximal area 14, which is shown larger than normal for purposes of illustration. The apparatus for developing a liquid spray, with a source of gas (air) and liquid is shown representationally at 11. An actual apparatus is shown and described in the '324 publication. The apparatus includes a nozzle 16 and a guidance tip 17 which together direct a stream of fluid droplets to the interproximal area. Although water may be generally preferred as a fluid, other fluids, with different viscosities, such as mouthwash and/or combinations of water with a small amount of disinfectant, such as alcohol, and/or a surfactant or other material, may also be used. The fluid droplets in some cases are mixed in with an accelerating airflow stream, such as in the '324 publication.

Referring to FIGS. 2A and 2B, some of the liquid droplets form fluid films 18 and 20 on the interproximal surfaces of the adjacent teeth 10 and 12. In addition to the droplets which produce fluid films 18 and 20 on the interproximal surfaces, other fluid droplets directly impact the biofilm on the interproximal surfaces, as shown in FIG. 1 and in closer detail in FIG. 5. The impacting droplets produce a shear stress which will vary depending on the angle of incidence.

The air (gas) flow, besides moving fluid droplets for impact on the teeth, will also drive fluid films 18 and 20 along the surface of the biofilm on the teeth. This produces a fluid film shear stress on the biofilm, in addition to the shear stress created by the impact of the droplets. The shear stress produced by air driving the liquid film can be determined as follows, using the interproximal dimensions shown in FIG. 2B. Referring also to FIG. 3, a liquid film of uniform thickness is assumed for the interproximal surfaces, the interproximal space having a width w, a length L and a height B. The fluid film has a width (thickness) h. The velocity profile of FIG. 3 assumes a substantially uniform air velocity and a fully developed liquid flow. The gas (air) velocity, with a gas flow rate of Q_{g}, can be found from the following equation:

$${U}_{g} = \frac{{Q}_{g}}{( w - 2 h ) B} \qquad ( 1 )$$

The average liquid velocity in the liquid film with a fluid flow rate Qₗ is determined by:

$${U}_{l , av} = \frac{{Q}_{l}}{2 h B} \qquad ( 2 )$$

It should be understood the liquid flow rate Qₗ of the films 18, 20 is smaller than the total liquid flow rate since some of the liquid produced will be traveling through the air as droplets to impact the interproximal surfaces, as opposed to being collected in the form of films on the surfaces of the teeth. The boundary conditions for the liquid flow rate are

$$y = 0 ⇒ {U}_{l} = 0 \\ y = h ⇒ \frac{d {U}_{l}}{d y} = 0 \qquad ( 3 )$$

The other boundary condition at the air-liquid interface, with y being the coordinate perpendicular to the flow of gas and liquid, indicates a continuing velocity

y=h [symbol] Uₗ=U_{g}. (4)

At the interface with the teeth, the velocity of the liquid film is zero, while at the interface with the air the shear stress is zero, with the liquid velocity and the air velocity being substantially equal. For fully developed liquid flow with viscosity μₗ, the velocity of the liquid is determined by the equation:

$${μ}_{l} \frac{{d}^{2} {U}_{l}}{d {y}^{2}} = \frac{d p}{d x} \qquad ( 5 )$$

where p is the pressure in the liquid film. With above boundary conditions, this equation can be solved as follows:

$${U}_{l} ( y ) = - \frac{1 d p}{{μ}_{l} d x} {h}^{2} [ \frac{y}{h} - \frac{{y}^{2}}{2 {h}^{2}} ] \qquad ( 6 )$$

The average velocity of the liquid in the film U_{l,av} follows from:

$${U}_{l , av} h = {\int }_{o}^{h} {U}_{l} ( y ) d y \qquad ( 7 )$$

Which gives the average velocity as:

$${U}_{l , av} = \frac{- 1}{{μ}_{l}} \frac{d ρ}{d x} \frac{{h}^{2}}{3} \qquad ( 8 )$$

The velocity profile can then be written as:

$${U}_{l} ( y ) = 3 {U}_{l , av} [ \frac{y}{h} - \frac{{y}^{2}}{2 {h}^{2}} ] \qquad ( 9 )$$

Accordingly, at y=h the liquid velocity is 3/2 times the average liquid velocity. Further, due to the continuing velocity at y=h,

$${U}_{l , av} = \frac{2}{3} {U}_{g} \qquad ( 10 )$$

With the above equations (1), (2) and (10), the thickness h of the liquid film is provided as follows:

$$h = \frac{w}{\frac{4 {Q}_{g}}{3 {Q}_{1}} + 2} \qquad ( 11 )$$

When the gas flow rate is much larger than the liquid flow rate, the equation simplifies to:

$$h = \frac{3 {Q}_{l}}{4 {Q}_{g}} w \qquad ( 12 )$$

In the case where substantially all the liquid is used for liquid film formation on the interproximal surfaces, using a 10 ml/min liquid flow and 3 l/min air flow, a thickness h of 2.5 μm for a width w of 1 mm results. This is quite a small number, and will be less when not all the liquid flow Qₗ is used for film formation, i.e. when some of the liquid is in the form of droplets which impact directly the interproximal surface.

The shear stress τ produced by the air-driven fluid follows:

$$\begin{matrix}τ = {μ}_{l} \frac{d u}{d y} y = 0 & ( 13 ) \\ and & \\ τ = 2 {μ}_{1} \frac{{U}_{g}}{h} & ( 14 )\end{matrix}$$

Hence, when the gas flow is 3 l/min and both w and B (the height of the teeth) are 1 mm, and with a typical gas velocity of 50 m/s, the typical air-driven fluid shear stress would be

4·10⁴ Pa

This is a significant value of shear stress, although the liquid film is quite thin and may not be stable in some cases, which in some circumstances could reduce the shear stress. Further, if the airflow is not substantially uniform, the shear stress will also be reduced. Nevertheless, the above indicates that a significant value of shear stress can be produced in the interproximal space by air action on a fluid film present on the interproximal surfaces.

As can be seen from FIGS. 1 and 4, interproximal cleaning is due to both shear stress caused by gas action on the fluid film, as well as the impact of fluid droplets on the interproximal surfaces, which is shown in FIG. 5. A teeth cleaning apparatus such as described in the '324 publication positions the nozzle 16 and guidance tip 17 to produce interproximal cleaning. Guidance tip 17 is shaped to conform to the mating interproximal surfaces of adjacent teeth 10 and 12.

In operation, fluid droplets 27 produced by the appliance will proceed from nozzle 16 through the forward end of guidance tip 17 and into the interproximal area, either forming a part of fluid films 18 and 20 (FIG. 2A) or directly impacting the surface of the teeth. The impacting droplets hit the interproximal surfaces of the teeth at various angles. Typically, the maximum angle will be 45°, as shown most clearly in FIG. 5, at the front of the interproximal area. The effect of the shear stress created by the impacting droplets and the shear stress produced by the movement of the gas against the interproximal fluid films is a surprisingly effective, advantageous interproximal cleaning.

The respective values of shear stress from the two sources, however, change with the depth of the interproximal space, i.e. at different values of L (see FIG. 2B), the deeper into the interproximal space, the respective values of shear stress will change. From the forward edge of the interproximal space, which is nearest the front surfaces of the teeth, into the interproximal space, there is an increase in the fluid flow shear on the interproximal surfaces, while there is a decrease in the shear from the impact of the droplets. The combination of the two shear forces, however, surprisingly, is sufficient to remove the biofilm from the interproximal surfaces over the entire depth of the interproximal space. The plaque biofilm that grows in the interproximal area, since it is not toughened by continuous contact with the tongue or cheek surfaces, is typically lower in strength than the biofilm on the front surfaces of the teeth, which is a factor in the combined shear stress being able to remove the biofilm in the interproximal space.

FIG. 4 is a diagram which shows the increase in fluid flow shear stress 32 with interproximal depth (up to 10 mm), with a decrease in droplet shear stress 34, due to the angle of impact necessarily decreasing with depth. The shear stress due to the impact of droplets is maximum at 0 interproximal depth, i.e. approximately at the point where the spray leaves the guidance tip 27 adjacent the teeth surfaces. The shear stress caused by the impacting droplets decreases as the distance from the guidance tip increases and the angle of impact decreases. The shear stress due to the air driven fluid increases with the interproximal distance and as the interproximal space between the teeth decreases, and is at a maximum when the interproximal space reaches a constant value. The droplet impact shear stress is minimum at approximately 5 mm, while the shear stress from the air-driven fluid film is minimum at 0 interproximal depth and maximum typically at 5 mm.

The sum of the two shear stress forces, shown at 38, however, always remains larger than the shear force necessary to remove the plaque biofilm over the entire interproximal depth, i.e. the shear force combination always at least matches the plaque strength. Accordingly, interproximal cleaning by the present apparatus is quite effective, at least as good as with flossing. With an interproximal gap of 1 mm, a gas flow rate of 3 l/min and a fluid flow rate of 10 cubic cm/min through a nozzle producing liquid droplets is sufficient to produce a substantial cleaning of the interproximal areas.

In one embodiment, the flow of fluid droplets and the gas are both continuous. In other embodiments, the fluid droplets and/or the gas have a pulsating flow. The frequency of fluid/gas flow pulses will typically be in the range of 0.1-100 Hz. This pulsing of the airflow and/or the fluid droplets increases the effect of the combined shear stress to produce good cleaning results.

Accordingly, an apparatus has been described by which effective interproximal cleaning occurs by a gas-driven fluid droplet spray, without the need for flossing.

Although a preferred embodiment of the invention has been disclosed here for the purposes of illustration, it should be understood that various changes, modifications and substitutions may be incorporated in the embodiment without departing from the spirit of the invention, which is defined by the claims which follow.

1. An apparatus for cleaning the interproximal areas of teeth, comprising:
a source of liquid droplets (11);
a source of gas (11) for driving the liquid droplets toward the teeth;
a nozzle and guidance tip (16, 27) for directing the liquid droplets into an interproximal area of the teeth, wherein the guidance tip is formed so that droplets are directed at a sufficient angle to impact interproximal surfaces and create a droplet impact shear stress on interproximal biofilm, and further so that a liquid film (18, 20) is produced on the interproximal surfaces, wherein gas from the source thereof drives said fluid film to create a fluid film shear stress on the interproximal biofilm, wherein the combination of the droplet impact shear stress and the fluid film shear stress is at least as great as the shear stress required to remove the biofilm on substantially the entire interproximal surfaces, producing a cleansing effect on the interproximal surfaces.

2. The apparatus of claim 1, wherein the shear stress at a front portion of the interproximal area is produced substantially by the impact of the droplets and decreases with the depth of interproximal space, and wherein the shear stress produced by the air-driven fluid film is at a minimum at the front portion of the interproximal area and increases with the depth of the interproximal space.

3. The apparatus of claim 1, wherein the gas is air.

4. The apparatus of claim 1, wherein a single source of air is used to accelerate the fluid droplets to the teeth and also to drive the fluid film along the interproximal surfaces.

5. The system of claim 1, wherein the fluid is water.

6. The system of claim 1, wherein the fluid is a substance which has a higher viscosity than water.

7. The system of claim 1, wherein the liquid droplets comprise pulses of droplets.

8. The system of claim 1, wherein the gas flows in pulses.

9. The system of claim 1, wherein the liquid droplets and/or the gas flow in pulses at a frequency in the range of 0.1-100 Hz.

10. The system of claim 1, wherein the gas is used to generate the fluid droplets.
